(19) United States
(12) Patent Application Publication
(10) Pub. No.: US 2018/0066406 A1
(43) Pub. Date: Mar. 8, 2018

(54) LEAD CORE RUBBER SEISMIC ISOLATION BEARING, INTELLIGENT BEARING AND BEARING MONITORING SYSTEM

(71) Applicants: Shenzhen Municipal Design & Research Institute Co., Ltd., Shenzhen City (CN); Shenzhen Innova-Wise Engeering Technology Consulting Co., Ltd., Shenzhen City (CN)

(72) Inventors: Jucan Dong, Shenzhen City (CN); Fang Yu, Shenzhen City (CN); Ruijuan Jiang, Shenzhen City (CN); Weiming Gai, Shenzhen City (CN); Jie Peng, Shenzhen City (CN); Yiyan Chen, Shenzhen City (CN)

(73) Assignees: Shenzhen Municipal Design & Research Institute Co., Ltd., Shenzhen City (CN); Shenzhen Innova-Wise Engineering Technology Consulting Co., Ltd., Shenzhen City (CN)

(21) Appl. No.: 15/811,205

(22) Filed: Nov. 13, 2017

Related U.S. Application Data
(63) Continuation of application No. PCT/CN2016/097568, filed on Aug. 31, 2016.

(30) Foreign Application Priority Data
Jul. 18, 2016 (CN) 201610565647.8

(51) Int. Cl. E01D 19/04; G01L 5/00

(52) U.S. Cl. CPC E01D 19/042; G01L 5/0019

(57) ABSTRACT

Disclosed are a lead core rubber seismic isolation bearing, an intelligent bearing and a bearing monitoring system, belonging to the technical field of bearings. The lead core rubber seismic isolation bearing comprises a top bearing plate, a bottom bearing plate, a lead core rubber bearing body and a base plate, wherein pressure sensing units are arranged between the top bearing plate and the base plate, or between the bottom bearing plate and the base plate. The intelligent bearing includes a data acquisition unit, a data output unit and the lead core rubber seismic isolation bearing, the data acquisition unit transmitting the bearing pressure measured by the pressure sensing unit to the data output unit. The bearing monitoring system includes a data acquisition unit, a data output unit, a monitoring center and the lead core rubber seismic isolation bearing.

### CROSS-REFERENCE TO RELATED APPLICATIONS

This application is a Continuation application of International Application No. PCT/CN2016/097568, filed Aug. 31, 2016, which claims the benefit of priority of Chinese Application No. 201610565647.8, filed Jul. 18, 2016, the contents which are incorporated herein by reference in their entirety.

### TECHNICAL FIELD

The present disclosure relates to the technical field of bearings, in particular to a lead core rubber seismic isolation bearing, an intelligent bearing and a bearing monitoring system.

### BACKGROUND

Currently, seismic isolation bearings are widely used in the field of bridges. Among which, lead core rubber bearings have been widely used in the actual bridge engineering in many countries around the world due to their remarkable isolation effects and the mature technology. In a bridge structure, the stability and reliability of the bearing which serves as a main force transfer component directly affects the safety performance of the entire bridge. Bearing failure will lead to the overall collapse of the entire bridge, resulting in immeasurable serious consequences, and therefore the long-term safety of the bearing is particularly important. For seismic isolation bearings using rubber materials, the rubber materials age over time and fatigue of metal components occurs as time passes. For different operating environments, the durability of the seismic isolation bearings and whether bearing failure occurs due to the influence of various factors such as aging of the rubber materials, metal fatigue, etc., are all related to the overall safety of the bridge. From the long-term health situation of the bridge, it is particularly important to monitor the health status of a seismic isolation bearing.

In the prior art, the monitoring of the force condition for the seismic isolation bearing mainly relies on a pressure sensing unit, and data information obtained after the sensing unit measures the pressure needs to be exported by a lead wire. Thus, there is a need to make micro-holes on the bearing to lead out the lead wire, thus causing the overall mechanical properties of the bearing to be affected. As the bridge bearing needs to bear a huge load, even tiny pores will cause huge safety risks. In addition, the replacement of the sensor unit is also a problem faced by the current bearing technology. Since the sensing unit is usually fixedly connected to the bearing body or embedded in the bearing, if the sensor unit is replaced, the entire bearing needs to be replaced, leading to a high cost and complicated operation.

### SUMMARY OF THE INVENTION

The technical problem to be solved by the disclosure is to provide a lead core rubber seismic isolation bearing which is capable of monitoring the force condition of the bearing in real time, does not affect mechanical properties of the bearing, and facilitates replacement of the pressure sensing unit.

The further technical problem to be solved by the disclosure is to provide an intelligent bearing and a bearing monitoring system which can monitor and reflect the health status of the bearing in real time.

The technical scheme that the disclosure adopts to solve the above technical problems is as follows.

It provides that a lead core rubber seismic isolation bearing, comprising a top bearing plate, a bottom bearing plate and a lead core rubber bearing body fixedly arranged between the top bearing plate and bottom bearing plate. The lead core rubber bearing body is internally provided with a lead core and further comprises a base plate stacked with the top bearing plate or bottom bearing plate, wherein a pressure sensing unit is arranged between the top bearing plate and the base plate or between the bottom bearing plate and the base plate.

As a further improvement of the above technical solution, the pressure sensing unit is a nano-rubber sensor.

As a further improvement of the above technical solution, the base plate and the nano-rubber sensor are arranged between the top bearing plate and the lead core rubber bearing body or between the bottom bearing plate and the lead core rubber bearing body.

As a further improvement of the above technical solution, the nano-rubber sensor comprises at least two fabric layers, and the adjacent fabric layers are filled with nano-conductive rubber which is a rubber substrate doped into carbon nanotubes.

As a further improvement of the above technical solution, a limit unit is arranged on a lateral side of the base plate which is subjected to a lateral force.

As a further improvement of the above technical solution, the limit unit is a strip-shaped steel bar or limit block, and is fixedly connected to the top bearing plate or the bottom bearing plate by bolts and abuts against the lateral side of the base plate.

As a further improvement of the above technical solution, the lead core rubber bearing body further comprises several layers of rubber sheets, steel plates arranged between the rubber sheets, and closing plates connected with the rubber sheets at an upper and a lower end face, wherein the rubber sheets and the steel plates, as well as the rubber sheets and the closing plates are bonded together through vulcanization.

The disclosure provides an intelligent bearing, comprising a data acquisition unit, a data output unit, and the lead core rubber seismic isolation bearing as described above, wherein the data acquisition unit transmits bearing pressure data measured by the pressure sensing unit to the data output unit.

The disclosure further provides a bearing monitoring system, comprising a data acquisition unit, a data output unit, a monitoring center and the lead core rubber seismic isolation bearing as described above. The data acquisition unit transmits bearing pressure data measured by the pressure sensing unit to the data output unit, and the data output unit transmits the pressure data to the monitoring center.

As a further improvement of the above technical solution, the monitoring center comprises a data receiving unit, a server, a monitoring unit, an analysis unit, and a human-computer interaction unit. The data receiving unit transmits the pressure data of the data output unit to the server, the monitoring unit, the analysis unit and the human-computer interaction unit.

The disclosure has the beneficial effects that:

1. The pressure sensing unit is arranged between the top bearing plate and the base plate, or between the bottom bearing plate and the base plate, and is therefore easy to replace, and a real-time monitoring of the force state for the bearing can be realized.

2. The lead wire of the pressure sensing unit is led out from between the top bearing plate and the base plate, or from between the bottom bearing plate and the base plate, thus there is no need to make micro-holes for the lead wire on the bearing, ensuring that the mechanical properties of the bearing are not affected.

3. The bearing monitoring system of the disclosure can instantaneously transmit the pressure data measured by the pressure sensing unit to the monitoring center which then monitors and analyzes the pressure data so as to monitor and reflect the health status of the bearing in real time.

### BRIEF DESCRIPTION OF THE DRAWINGS

FIG. 1 is a cross-sectional view of an overall structure of a lead core rubber seismic isolation bearing in the 1st embodiment of the disclosure;

FIG. 2 is a cross-sectional view of the overall structure of the lead core rubber seismic isolation bearing in the 2nd embodiment of the disclosure;

FIG. 3 is a schematic view of an overall structure of a nano-rubber sensor of the lead core rubber seismic isolation bearing of the disclosure; and

FIG. 4 is a schematic view showing the connection of modules of a bearing monitoring system of the disclosure.

### DETAILED DESCRIPTION OF THE EMBODIMENTS

In order that the objects, features and effects of the disclosure may be fully understood, a full and clear description of concepts, specific structures and technical effects produced of the disclosure will be made below in connection with embodiments and accompanying drawings. Obviously, the embodiments described are merely a part, but not all embodiments of the disclosure. Based on the embodiments of the disclosure, other embodiments obtained by the skilled in the art without inventive effort should all belong to the protection scope of the disclosure. In addition, all the coupling/connecting relationships mentioned herein do not merely refer to direct connection or coupling of members, but rather a better coupling structures formed by adding or subtracting coupling accessories according to specific implementation. Technical features of the disclosure may be combined as long as they are not mutually contradictory.

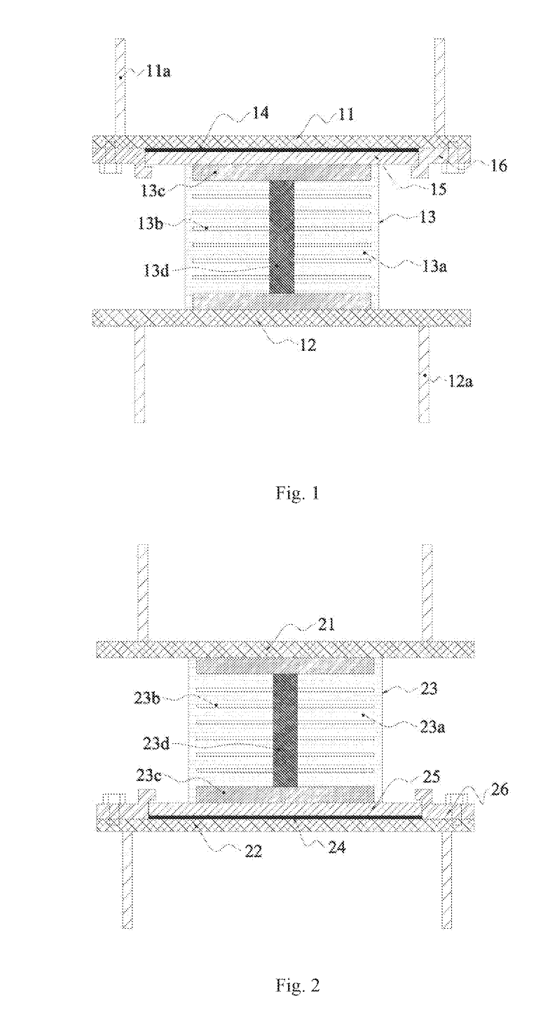

FIG. 1 shows a specific structure of a lead core rubber seismic isolation bearing in the first embodiment of the disclosure. As shown in FIG. 1, the lead core rubber seismic isolation bearing of the disclosure comprises a top bearing plate 11, a bottom bearing plate 12, a lead core rubber bearing body 13, a nano-rubber sensor 14, a base plate 15 and a limit unit 16. A top anchor bolt 11a is fixedly provided on the upper surface of the top bearing plate 11, and a bottom anchor bolt 12a is fixedly provided on the lower surface of the bottom bearing plate 12a, the top sleeve 11a and the bottom sleeve 12a being used for fixed connection with constructions such as bridges, etc.

The lead core rubber seismic isolation bearing adopts the nano-rubber sensor 14 to detect the force condition of the bearing in real time, and then obtains the vertical pressure variation value of the bearing. As the nano-rubber sensor 14 is thin in thickness and simple in structure, it does not affect various mechanical properties of the bearing. As the rubber has good fatigue resistance and high temperature resistance, the nano-rubber sensor 14 has a high durability and a number of alternating stress cycles greater than 50 million.

In preferred embodiments of the disclosure, the nano-rubber sensor 14 is used as a pressure measuring unit. Of course, other pressure sensors can also be used, such as but not limited to, a strain gauge pressure sensor, a ceramic pressure sensor, a diffused silicon pressure sensor, a piezoelectric pressure sensor, etc.

The nano-rubber sensor 14 and the base plate 15 are sequentially arranged in a top-down order between the top bearing plate 11 and the lead core rubber bearing body 13. The limit unit 16 is arranged on a lateral side of the base plate 15 which is subjected to a lateral force, so as to ensure the stability of the base plate 15 under the effect of the lateral force. In different embodiments, the base plate 15 can also be arranged above the top bearing plate 11, so long as the base plate 15 and the top bearing plate 11 are stacked and have the nano-rubber sensor 14 arranged therebetween.

The limit unit 16, which is preferably a strip-shaped steel bar or limit block, is fixedly connected to the top bearing plate 11 by bolts and abuts against the lateral side of base plate 15. Of course, the shape, the fixed position and fixed manner of the limit unit 17 are not limited to the above-described embodiments, as long as the limiting function is achieved. The limit unit 16 and the top bearing plate 11 are connected by bolts to facilitate the replacement of the nano-rubber sensor 14. In case of replacement, the limit unit 16 is taken off first, and then the top bearing plate 11 together with the construction thereabove is jacked using a jacking device, thus the nano-rubber sensor 14 can be replaced.

The lead core rubber bearing body 13 comprises several layers of rubber sheets 13a, steel plates 13b arranged between the rubber sheets 13a, a lead core 13d penetrating the rubber sheets 13a and closing plates 13c connected with the rubber sheets 13a at an upper and a lower end face, wherein the rubber sheets 13a and the steel plates 13b, as well as the rubber sheets 13a and the closing plates 13c are bonded together through vulcanization. The closing plate 13c at the top of the rubber sheet 13a is fixedly connected with the base plate 15 by bolts, and the closing plate 13c at the bottom is fixedly connected with a bottom supporting plate 12 by bolts.

In order to accurately measure the force condition of the entire bearing and ensure the monitoring validity under the partial load, preferably, an array of the nano-rubber sensors 14 is arranged between the top bearing plate 11 and the base plate 15. A high-temperature-resistance shielding lead wire connecting two electrodes of the nano-rubber sensor 14 is led out from a gap between the base plate 15 and the top bearing plate 11, thus there is no need to make micro-holes for the lead wire on the bearing, effectively ensuring the mechanical properties of the bearing.

FIG. 2 shows a specific structure of the lead core rubber seismic isolation bearing in the second embodiment of the disclosure. As shown in FIG. 2, the lead core rubber seismic isolation bearing of the disclosure comprises a top bearing plate 21, a bottom bearing plate 22, a lead core rubber bearing body 23, a nano-rubber sensor 24, a base plate 25 and a limit unit 26. The difference between this embodiment and embodiment 1 lies in that the nano-rubber sensor 24 and the base plate 25 are arranged between the bottom bearing plate 22 and the lead core rubber bearing body 23. Similarly, in different embodiments, the base plate 25 can also be arranged below the bottom bearing plate 21, so long as the base plate 25 and the bottom bearing plate 21 are stacked and have the nano-rubber sensor 24 arranged therebetween.

The lead core rubber bearing body 23 comprises several layers of rubber sheets 23a, internally provided steel plates 23b, a lead core 23d and closing plates 23c fixedly connected with the rubber sheets 23a through vulcanization, wherein the rubber sheets 23a and the internally provided steel plates 23b are also bonded together through vulcanization, and the base plate 25 is fixedly connected with the closing plate 23c at the lower end of the rubber sheets 23a by bolts.

The limit unit 26 is fixedly connected with the bottom bearing plate 22 by bolts and is arranged at a lateral side of the base plate 25 which is subjected to a lateral force.

In this embodiment, upon replacing the nano-rubber sensor 24, the top bearing plate 21, the construction above the top bearing plate 21, the lead core rubber bearing body 23 and the base plate 25 are simultaneously jacked up so as to allow replacement of the nano-rubber sensor 24.

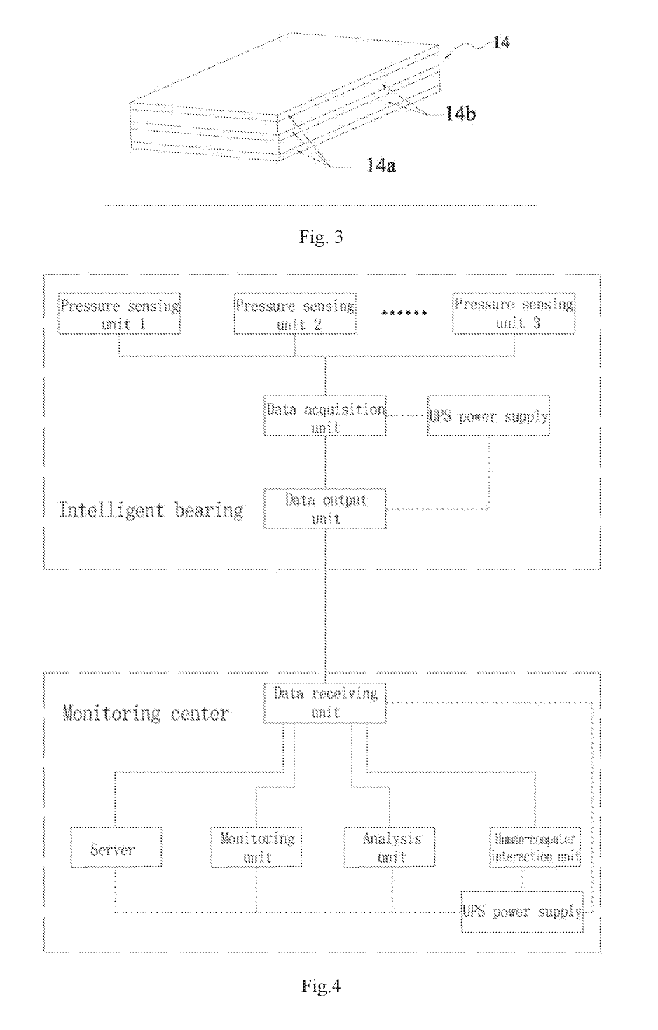

FIG. 3 shows a schematic view of the overall structure of the nano-rubber sensor 14 of the lead core rubber seismic isolation bearing of the disclosure.

The operating principle of the nano-rubber sensor is as follows: the nano-rubber sensor is deformed under the action of an external load, so that the distance between conductive particles in the conductive rubber and a conductive network formed by the conductive particles is changed, showing changes in the resistivity and resistance of the conductive rubber, thus causing changes in the measurement of electrical signals. Then, according to the piezoresistive characteristics of the conductive rubber, the force condition of a pressure bearing surface can be obtained by derivation.

Preferably, the nano-rubber sensor 14 is of a multilayer structure, wherein as skeleton layers, a plurality of high strength fabric layers 14a are distributed at intervals from top to bottom, and nano-conductive rubber 14b of a certain thickness is filled between the fabric layers 14a. The fabric layers 14a are dense in texture, and have a certain thickness, elasticity and strength, satisfying the requirement of elastic deformation under a high pressure without damage. Preferably, the fabric layers 14a are made of elastic fibers such as medium or high spandex, high elastic nylon, etc. At the same time, there are gaps in the texture formed by the vertical and horizontal fibers of the fabric layers 14a, which ensure that a nano-conductive rubber solution covered on the fabric layers 14a can penetrate into the gaps during preparation, thereby enhancing the integrity of the structure. The rubber substrate material of the nano-conductive rubber 14a is polydimethylsiloxane rubber (PDMS) consisting of basic constituents and a curing agent in a mixing ratio of 10:1 conductive fillers are carbon nanotubes, preferably multi-walled carbon nanotubes (MWCNT). The mass percentage of the multi-walled carbon nanotubes is between 8% and 9%.

The high strength fabric layers 14a are added to the nano-rubber sensor 14 as a stiff skeleton, which significantly improves the strength and toughness of the nano-rubber sensor 14 under a high pressure of 0 to 50 MPa, avoiding tearing and ensuring the stability and repeatability of such sensing unit under high pressure.

The preparation of nano-rubber sensor is carried out mainly by solution blending and molding. The specific preparation method comprises the following steps:

S1, ingredient mixing: weighing the basic constituents of polydimethylsiloxane rubber (PDMS), the curing agent and carbon nanotubes in accordance with a mass ratio, pouring the mixture into a mixer, and grinding and mixing the same mechanically at room temperature to ensure that the carbon nanotubes are uniformly distributed in the rubber substrate to make the nano-conductive rubber solution.

S2, synthesis: preparing a plurality of high-strength fabrics of the same size, laying a fabric layer on a bottom plate of a mold, uniformly coating the nano-conductive rubber solution prepared in S1 onto the fabric at a certain thickness, and then laying another fabric layer on the same, wherein depending on the thickness demand of nano-conductive rubber sensing elements, the process of coating the nano-conductive rubber solution and additionally laying the fabric layer can be repeated.

S3, curing: placing a top plate of the mold on the uppermost fabric layer of the uncured nano-rubber sensor; through the connection between the upper, lower, top and bottom plates of the mold, applying a certain pressure to the nano-conductive rubber material to ensure uniformity and compactness of the thickness thereof; and placing the mold in a container at 60° C., vacuuming the container and leaving it for at least 300 min.

After the nano-rubber sensor is cured, the cured sheet type nano-rubber sensor can be cut into the desired sizes and shapes by machining tools according to design requirements of the sensor. After connecting the electrodes and the insulating protective layer, a sheet-type flexible nano-conductive rubber pressure sensor having a large measuring range is fabricated.

FIG. 4 is a schematic diagram showing the connection of modules of a bearing monitoring system of the disclosure. The bearing monitoring system of the disclosure includes an intelligent bearing and a monitoring center.

The intelligent bearing comprises the lead core rubber seismic isolation bearing as described above, a data acquisition unit, a data output unit, and a UPS power supply. The data acquisition unit acquires pressure data of each of the nano-rubber sensors in the lead core rubber seismic isolation bearing. The data output unit is preferably an optical wireless switch, which transmits the pressure data to the monitoring center. The UPS provides uninterrupted power to the electricity-consuming modules in the intelligent bearing.

The monitoring center comprises a data receiving unit, a server, a monitoring unit, an analysis unit, a human-computer interaction unit and a UPS power supply. The data receiving unit is also preferably an optical wireless switch, which is used to receive the pressure data transmitted by the data output unit. The data receiving unit transmits the received data to the server, the monitoring unit, the analysis unit and the human-computer interaction unit, the server manages and controls the data, the monitoring unit performs instant monitoring on the data, and the analysis unit evaluates and analyzes the data. The UPS power supply provides uninterrupted power to the electricity-consuming modules in the monitoring center.

Through the acquisition, transmission, monitoring and analysis performed on the monitoring data of the bearing, the bearing monitoring system can instantly understand and judge the health status of the bearing to ensure the safe use of the bearing.

Preferred embodiments of the disclosure have been described above, but the disclosure is not limited thereto. Numerous variations, substitutions and equivalents may be made by those skilled in the art without departing from the spirit of the disclosure and should all fall within the scope defined by the claims of the application.

What is claimed is:

1. A lead core rubber seismic isolation bearing, comprising:
a top bearing plate;
a bottom bearing plate;
a lead core rubber bearing body fixedly arranged between the top bearing plate and the bottom bearing plate, the lead core rubber bearing body being internally provided with a lead core; and
a base plate stacked with the top bearing plate or the bottom bearing plate, wherein at least one pressure sensing unit is arranged between the top bearing plate and the base plate, or between the bottom bearing plate and the base plate.

2. The lead core rubber seismic isolation bearing according to claim 1, wherein the pressure sensing unit is a nano-rubber sensor.

3. The lead core rubber seismic isolation bearing according to claim 2, wherein the base plate and the nano-rubber sensor are arranged between the top bearing plate and the lead core rubber bearing body or between the bottom bearing plate and the lead core rubber bearing body.

4. The lead core rubber seismic isolation bearing according to claim 2, wherein the nano-rubber sensor comprises at least two fabric layers, and the adjacent fabric layers are filled with nano-conductive rubber which is a rubber substrate doped into carbon nanotubes.

5. The lead core rubber seismic isolation bearing according to claim 1, wherein a limit unit is arranged on a lateral side of the base plate which is subjected to a lateral force.

6. The lead core rubber seismic isolation bearing according to claim 5, wherein the limit unit is a strip-shaped steel bar or limit block, and is fixedly connected to the top bearing plate or the bottom bearing plate by bolts and abuts against the lateral side of the base plate.

7. The lead core rubber seismic isolation bearing according to claim 1, wherein the lead core rubber bearing body further comprises several layers of rubber sheets, steel plates arranged between the rubber sheets, and closing plates connected with the rubber sheets at an upper and a lower end face, wherein the rubber sheets and the steel plates, as well as the rubber sheets and the closing plates are bonded together through vulcanization.

8. An intelligent bearing, comprising a data acquisition unit, a data output unit, and the lead core rubber seismic isolation bearing according to claim 1, wherein the data acquisition unit transmits bearing pressure data measured by the pressure sensing unit to the data output unit.

9. A bearing monitoring system, comprising: a data acquisition unit, a data output unit, a monitoring center and the lead core rubber seismic isolation bearing according to claim 1, wherein the data acquisition unit transmits the bearing pressure data measured by the pressure sensing unit to the data output unit, and the data output unit transmits the pressure data to the monitoring center.

10. The bearing monitoring system according to claim 9, wherein the monitoring center includes a data receiving unit, a server, a monitoring unit, an analysis unit and a human-computer interaction unit, wherein the data receiving unit transmits the pressure data of the data output unit to the server, the monitoring unit, the analysis unit and the human-computer interaction unit.
